(19) United States
(12) Patent Application Publication
(10) Pub. No.: US 2011/0011818 A1
(43) Pub. Date: Jan. 20, 2011

(54) ROTORHOOK

(76) Inventor: Thomas P. Corcoran, Eldridge, MO (US)

Correspondence Address: LANE & WATERMAN LLP, 220 N. MAIN STREET, SUITE 600, Davenport, IA, 52801, US

(21) Appl. No.: 12/818,647

(22) Filed: Jun. 18, 2010

Related U.S. Application Data
(63) Continuation-in-part of application No. 12/156,424, filed on Jun. 2, 2008, now abandoned.

(30) Foreign Application Priority Data
Aug. 26, 2009 (US) PCT/US2009/002133

(51) Int. Cl. B66C 1/34; B66C 13/00

(52) U.S. Cl. 212/270; 294/82.15

(57) ABSTRACT

A load lifting device is provided. The load lifting device has a housing, a load lifting hook assembly mounted with the housing, a freely rotatable swivel mounted with the housing opposite the load lifting hook assembly, wherein the freely rotatable swivel can rotate around a vertical axis, and a rotational driving device located within the housing, wherein the rotational driving device interacts with the load lifting hook assembly and controls movement of the load lifting hook assembly along a vertical axis. The rotational driving device controls movement of the load lifting device remotely through a power source, remote processing unit, motor, and remote control. The load lifting device is built to be attached to a hoist line of a crane and be used by riggers or other workers to move material and equipment.

### CROSS-REFERENCE TO RELATED APPLICATIONS

This application is a continuation-in-part of and claims priority from U.S. patent application Ser. No. 12/156,424, filed Jun. 2, 2008, entitled Rotorhook; herein incorporated by reference in its entirety.

### TECHNICAL FIELD

The present disclosure relates to load lifting devices used to lift construction material or other types of heavy material. More particularly, the embodiments of the present disclosure encompass a loading lifting device comprising a freely rotatable swivel, housing, hook assembly, and rotational driving device. A method of using the load lifting device is also contemplated.

### BACKGROUND

There are a number of devices having hooks on which loads are carried; however, with these known devices, the operator of the device is unable to easily rotate the load being lifted without the cables to the device twisting or without the use of one or more tether ropes. Requiring the operator to manually handle tether ropes close to the load is both physically demanding and dangerous. A load lifting device that solves the problem of twisting cables and the need for tether ropes while providing for remote control of the load is therefore needed.

### SUMMARY

In one aspect, the present disclosure is directed toward a load lifting device. The load lifting device includes a housing, a load lifting hook assembly mounted with the housing, a freely rotatable swivel mounted with the housing opposite the load lifting hook assembly, wherein the freely rotatable swivel can rotate around a vertical axis, and a rotational driving device located within the housing, wherein the rotational driving device interacts with the load lifting hook assembly and controls movement of the load lifting hook assembly along a vertical axis. The housing and freely rotatable swivel may be many different shapes. For example in exemplary embodiments, the housing is spherical or cylindrical and the freely rotatable swivel is a hook or a ring. Both the load lifting hook assembly and the freely rotatable swivel may be mounted to apertures in the housing using a bearing assembly and a shaft.

In an exemplary embodiment, the housing contains a recess for the rotational driving device. In some embodiments, the rotational driving device is supported by a platform. The rotational driving device controls the movement of the load lifting device and generally comprises a motor, a remote processing unit, a power source, and a remote control. The motor may be any type of DC motor such as a servo electric drive motor or stepper motor. The power source is similarly non-limiting, but in many cases will be a rechargeable battery.

Consistent with a further aspect of the disclosure, a method is provided for using the load lifting device. Initially, the load lifting device will be attached via the freely rotatable swivel to an applicable device used to handle the load, i.e. a crane. The method includes placing the load lifting device over a load that is to be lifted and moved. The load lifting device is attached to the load through the load lifting hook assembly. The load is then lifted and moved to a desired destination, where the load lifting device and the load are placed into position so that the load can be removed from the load lifting device. Finally, the load is removed from the load lifting device.

Control of the rotation of the hook assembly of the load lifting device, including the steps of placing the load lifting device over the load and moving the load to the desired location and positioning can be controlled automatically and remotely.

### BRIEF DESCRIPTION OF THE DRAWINGS

FIG. 1 is an isometric view of a spherical embodiment of the load lifting device. FIG. 1 depicts the load lifting device without the cover such that the interior of the load lifting device and the rotational driving device can be seen.

FIG. 2 illustrates an exploded view of the pieces of load lifting device in a spherical embodiment. The dotted lines in FIG. 2 demonstrate the position of various pieces of the load lifting device when the load lifting device is operational.

FIG. 3 shows a view of an alternative embodiment where the housing is cylindrical in shape;

FIGS. 4a and 4b demonstrate an example connection of the freely rotatable swivel to the load lifting device housing; and

FIG. 5 is a flow diagram depicting an exemplary disclosed method of using the load lifting device.

### DETAILED DESCRIPTION

Before describing the exemplary embodiments in detail, it is to be understood that the embodiments are not limited to particular machines or methods, as the machines and methods can, of course, vary. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which an embodiment pertains. Many methods and materials similar, modified, or equivalent to those described herein can be used in the practice of the current embodiments without undue experimentation.

As used in this specification and the appended claims, the singular forms “a”, “an” and “the” can include plural referents unless the content clearly indicates otherwise. Thus, for example, reference to “a component” can include a combination of two or more components.

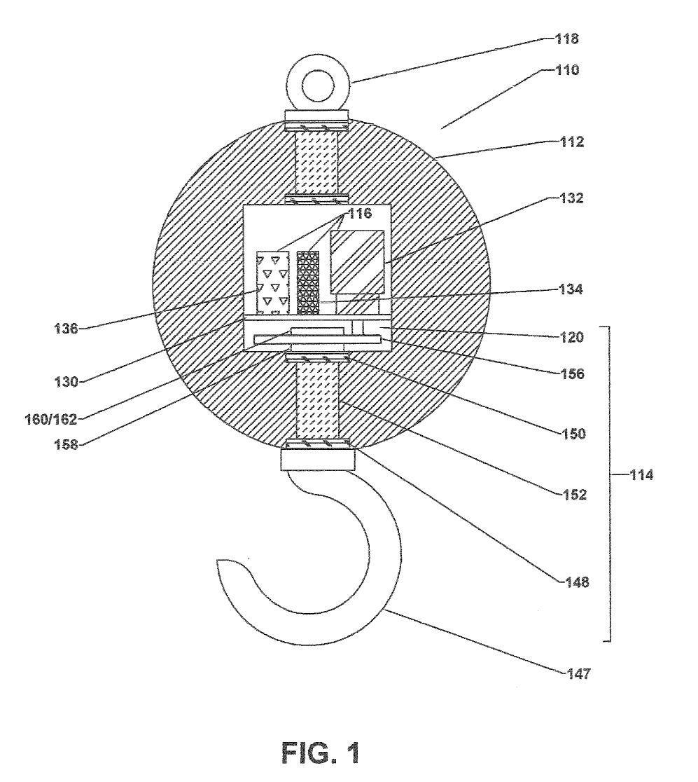

Embodiments of the load lifting device will now be explained with reference to the figures. This description is provided in order to assist in the understanding of the invention and is not intended to limit the scope of the invention to the embodiments shown in the figures or described below. Referring now to FIG. 1, in its broadest aspect, load lifting device 110 comprises a housing 112, a load lifting hook assembly 114, a rotational driving device 116 and a freely rotatable swivel 118.

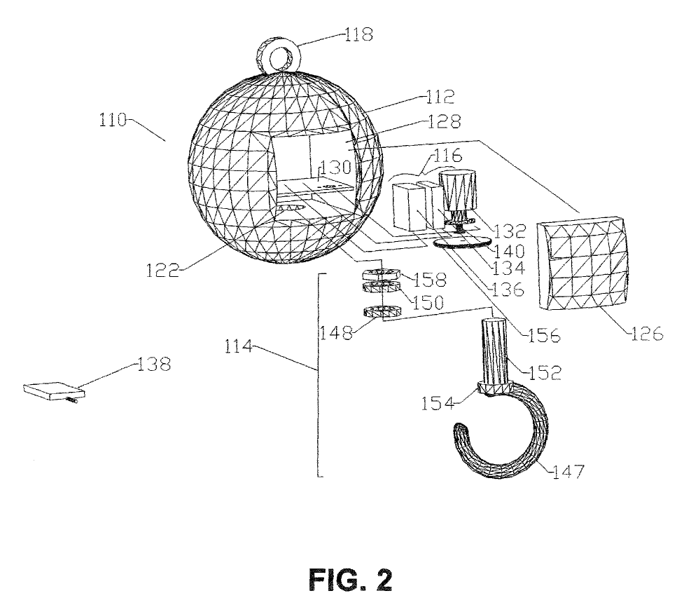

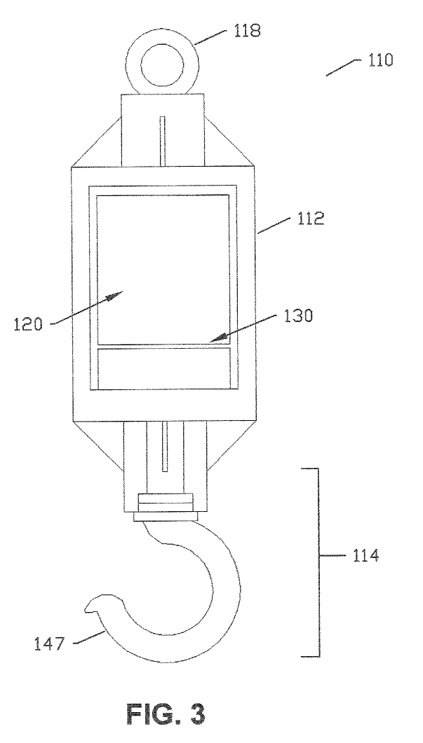

Referring first to housing 112, the shape of housing 112 is not meant to be limiting. As long as housing 112 is capable of housing rotational driving device 116, housing 112 may be any shape. For example, in addition to the spherical shape demonstrated in FIG. 1 and FIG. 2, housing 112 may be square, rectangular, or any other shape known in the art. In one embodiment housing 112 is a sphere that is sixteen inches in diameter. FIG. 3 demonstrates an embodiment where housing 112 is cylindrical in shape. In one aspect of this embodiment, housing 112 is a cylinder that is about 10 inches in diameter and about 14 inches housing length. In one of the cylindrical embodiments, the total length of the load lifting device is about 35 inches.

Housing 112 may be made from any appropriate material known to the skilled artisan. As used herein, an appropriate material is one having enough strength to allow the load lifting device to lift construction material and other heavy material, i.e. enough strength to lift the applicable load. For example, steel is an appropriate material as are aluminum, brass, stainless steel and cast iron. Steel materials include mild to tempered steel. Aluminum materials include cast to extruded. Brass materials include cast and extruded as does stainless steel. In many embodiments, the size and material of housing 112 will be rated for at least 15 tons.

As best shown in FIG. 2, the internal portion of housing 112 contains recess 120 and two apertures opposite each other, 122 and 124. Recess 120 has a cover 126 and is accessible through opening 128 from the exterior of housing 112. Recess 120 is generally cubed in shape and centered in housing 112. However, recess 120 may be any shape and size capable of housing rotational driving device 116. In one embodiment, recess 120 is a 7 inch by 7 inch cube. In other embodiments, recess 120 will be spherical. Cover 126 fits into opening 128 and protects recess 120 during operation of load lifting device 110. Generally cover 126 is permanently affixed into opening 128 during operation of load lifting device 110, such as, for example by bolts. In one embodiment, cover 126 is bolted to housing 112 with four quarter inch bolts. However, other ways of securing cover 126 are contemplated. For example, in other embodiments, cover 126 is pressure fitted into opening 128. Additionally, in one embodiment cover 126 is attached to housing 112 with hinges. Cover 126 may be attached to housing 112 either on the exterior or interior.

The shape of cover 126 is not meant to be limiting and may be any shape know in the art. However, generally, if housing 112 is spherical in shape, cover 126 follows the same contour such that when cover 126 is attached, a full sphere is formed.

Recess 120 also has apertures 122 and 124. Apertures 122 and 124 may be countersunk in the bottom and top of recess 120. In one embodiment, apertures 122 and 124 are two inches in diameter. However, the size and shape of apertures 122 and 124 are not meant to be limiting and can be any size or shape that allows for attachment of hook assembly 114 and fully rotatable swivel 118 to housing 112. The position of apertures 122 and 124 in recess 120 may also vary depending on the embodiment. In one embodiment, wherein housing 112 is a sphere with a sixteen inch diameter and recess 120 is a 7 inch by 7 inch cube, apertures 122 and 124 are centered across from each other.

In certain embodiments, recess 120 includes a platform 130. As demonstrated in FIG. 1, platform 130 is designed to support rotational driving device 116. Platform 130 may be made of any material capable of supporting the applicable rotational driving device 116. The shape of platform 130 is generally adapted to fit the shape of recess 120 and is not meant to be limiting. Nor is the material of platform 130 meant to be limited. For example, in one embodiment, platform 130 is made of steel. The position of platform 130 within recess 120 depends on applicable rotational driving device 116 and the dimensions of recess 120. For example, when recess 120 is a 7 inch by 7 inch cube and the tallest portion of rotational driving device is about 4 inches, platform 130 may be about 2.75 inches above the floor of recess 120. In embodiments where recess 120 is a different shape, platform 130 may be an equal ratio distance away from the floor of recess 120. For example, if recess 120 is 10 inches in height, platform 130 may be about 3.9 inches from the floor of recess 120. Platform 130 may be attached to housing 112 by any means known in the art. In one embodiment, platform 130 is welded to housing 112. In many embodiments, recess 120 will have only a single platform 130. However, in some individual embodiments, more than a single platform may be present in recess 120.

Rotational driving device 116 is largely housed within recess 120 and controls the movement of hook assembly 114. Rotational driving device 116 generally encompasses a motor 132, a remote processing unit 134, a power source 136, and a remote control 138, such as is shown in FIG. 2. For example, in the embodiment of FIG. 2, motor 132 is positioned on platform 130. Generally any type of DC motor is contemplated. In one embodiment, motor 132 is a geared motor with a shaft 140. Motor 132 may be a servo electric drive motor. A servo electric drive motor may be a one quarter horsepower motor. The drive components of the geared motor are stainless steel in many embodiments. In certain embodiments, especially in those embodiments where computer controls are used, the motor is a stepper motor. In most embodiments, motor 132 is supported by platform 130; however, in some embodiments, platform 130 is missing or more than a single platform is housed within recess 120 to support rotational driving device 116.

Power source 136 is any power source known in the art. In many embodiments, power source 136 is at least one battery. In some embodiments, more than a single battery is used. When power source 136 is a battery, the battery is permanently affixed to platform 130 in exemplary embodiments. In one embodiment, the battery is rechargeable. If the embodiment has more than a single battery, one battery or more than one battery is rechargeable. The batteries may be rechargeable using a dual charger. In other embodiments, power source 136 is solar. In yet other embodiments, power source 136 is a conventional source such as an electrical outlet. A rechargeable battery is recharged with a recessed hookup on the exterior of housing 112. Recessed hookups are well known in the art and the shape and specifications of the recessed hookup are not meant to be limiting. The exterior of housing 112 may also contain a toggle switch to turn off load lifting device 110 when the battery is charging and a push activation button with light symbols to alert the operator to the amount of charge. Any elements on the exterior of housing 112 may be protected using a shield.

Remote processing unit 134 controls motor 132. Generally, in order for remote processing unit 134 to control motor 132, remote processing unit 134 and motor 132 run on the same computer platform. Examples of the computer platform that may be used, include, but are not limited to computer aided control capable of prepositioning on a XYZ direction grid pattern, for example CNC computer software. When using computer aided controls, in certain embodiments, sensors will be attached to keep track of the number of turns so that the position of the load can be tracked. An exemplary embodiment has the sensors attached to a shaft of the load lifting hook assembly 114 and/or freely rotatable swivel 118. In some embodiments, the load lifting device includes sensors capable of detecting radioactive materials and x-ray sensors. These sensors are known in the art and not meant to be limiting.

In an exemplary embodiment, remote processing unit 134 is placed near motor 132 in recess 120 such that it can control motor 132 subsequent to receiving input from remote control 138. In many embodiments, remote processing unit 134 will be permanently affixed to platform 130 in a position next to motor 132 although other types of affixation and position, such as non-permanent affixation in a position next to power source 136 and not motor 132, are contemplated. In one embodiment, remote processing unit 134 is permanently affixed by bolts. In exemplary embodiments, remote processing unit 134 is controlled by remote control 138. Input from remote control 138 may be in the form of radio waves, electromagnetic frequencies, or infrared frequencies. All of these remote systems are well known in the art and not meant to be limiting.

Rotational driving device 116 allows an operator to control load lifting hook assembly 114 in both a clockwise and counterclockwise direction. An operator can also control the speed of the movement of loading lifting hook assembly 114. Load lifting hook assembly 114 comprises hook 147 and is connected with rotational driving device 116. In many embodiments load lifting hook assembly 114 also includes bearing assemblies 148 and 150, which may be tapered bearing assemblies. With tapered bearing assemblies, generally the smaller diameters of the bearings face each other in load lifting device 110. Load lifting hook assembly 114 also includes shaft 152 in many instances.

In one embodiment, hook 147 has a 1.5 inch girth by 1 inch thickness with a 3 inch interior radius of 270 degrees with a 90 degree opening. However, the specifications of hook 147 are not meant to be limiting and hooks that have different degrees of interior radius and different degree openings are contemplated. Hooks with different girths and thicknesses are also contemplated. The material used to make hook 147 is not limited but may be any applicable material known in the art.

In exemplary embodiments, hook 147 is made as a single piece with shaft 152. In the embodiments of FIG. 1 and FIG. 2, shaft 152 is two inches in diameter and includes a three inch diameter collar 154. Collar 154 provides a backstop for bearing assembly 148. Collar 154 also provides a place to seal for the retention of grease in certain embodiments. Collar 154 varies in size based on the size of load lifting device 110. Shaft 152 may be any appropriate length, such as about 5 inches, about 7 inches, about 10 inches, and more than 10 inches. The length of shaft 152 is dependent upon the distance from the exterior of housing 112 to recess 120. For example, if housing 112 is a 16 inch diameter sphere with shaft 152 being about seven inches long beyond collar 154. In some embodiments, shaft 152 is threaded. In one embodiment, shaft 152 is threaded its last inch of length.

During construction of load lifting device 110, bearing assemblies 148 and 150 are placed onto shaft 152. Generally, shaft 152 protrudes into recess 120. In one embodiment, shaft 152 protrudes into recess 120 about 2.5 inches. Gear 156, which is part of rotational driving device 116, interacts with the protrusion of shaft 152 as well as motor 132. Gears can be various sizes, even within a single load lifting device 110. In one embodiment, gear 156 is a 4.5 inch diameter by 0.75 inch thick main gear fitted with a 0.25 inch gear key. In an embodiment with a cylindrical housing, gear 156 is a 6 inch diameter by ⅜ inch thick main gear with a matching drive gear. In many embodiments, the torque of gear 156 will be about 10 pounds.

As demonstrated by FIG. 1 and FIG. 2, girth sleeve 158 placed on shaft 152 between bearing assembly 148 and gear 156. Girth sleeve 158 serves as a spacer between bearing assembly 148 and gear 156. In one embodiment, girth sleeve 158 specifications are 0.75 inch by 2 inch inside diameter by 0.25 inch. Nevertheless, the size and shape of appropriate girth sleeves is well known in the art and not meant to be limiting.

In exemplary embodiments, as most easily seen in FIG. 1, a locking ring 160 and hex nut 162 are fitted on the end of shaft 152, after gear 156 has engaged shaft 152. Hex nut 162 allows gear 156, bearing assemblies 148 and 150, and shaft 152 to be tightened together such that bearings assemblies 148 and 150 press toward each other and lock into place on shaft 152.

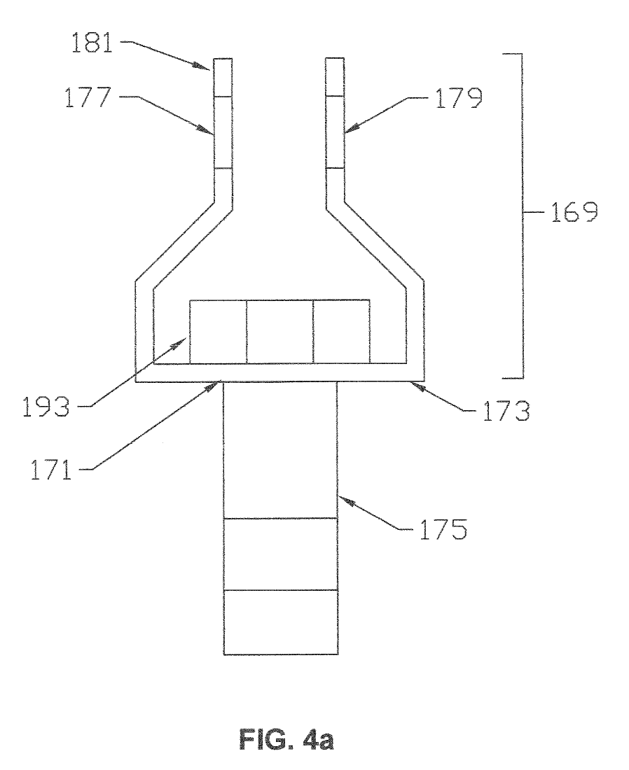

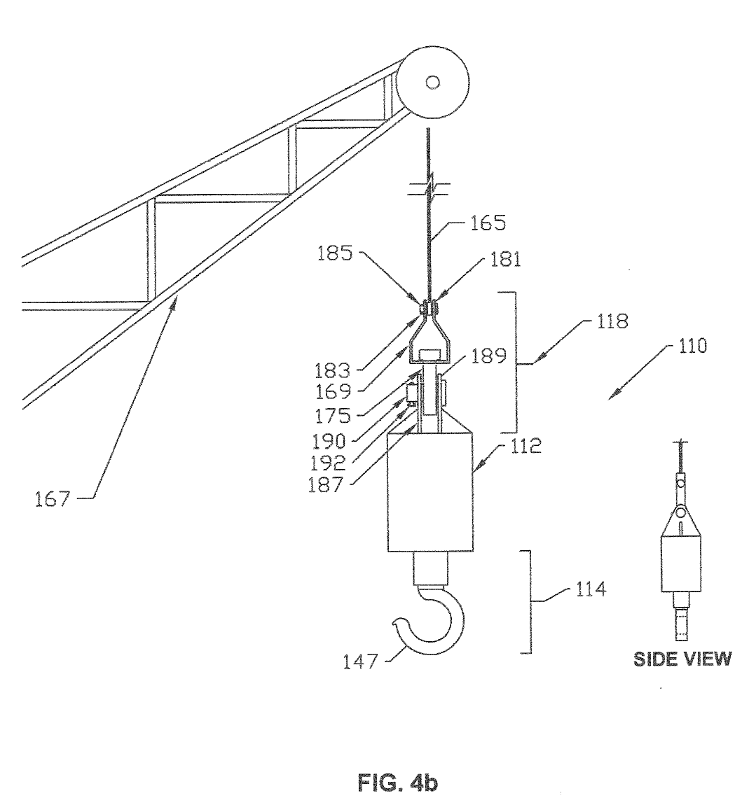

As demonstrated best by FIGS. 4a and 4b, load lifting device 110, also includes a freely rotatable swivel 118 mounted to housing 112 opposite load lifting hook assembly 114. An advantage of the use of freely rotatable swivel 118 in lifting loads is that freely rotatable swivel 118 allows load lifting device to turn without twisting attached cables. Freely rotatable swivel 118 is especially adapted to be connected to the hoist line 165 of a crane 167 although attachment to other devices is contemplated. Freely rotatable swivel 118 is capable of rotating 360 degrees. In many embodiments, freely rotatable swivel 118 is a ring. However, other shapes are contemplated. For example, in one embodiment freely rotatable swivel 118 may be a hook shape.

In the embodiment shown in FIG. 4a, freely rotatable swivel 118 comprises an element that is a semi-hourglass shape. In FIG. 4a, semi-hourglass 169 has hole 171 in proximal end 173 such that a shaft 175 can be placed through hole 171. Hole 171 allows shaft 175 to rotate freely within semi-hourglass 169. In some embodiments, shaft 175 is mounted to housing similarly to load lifting hook assembly 114, i.e. with bearing assemblies. In this embodiment, freely rotatable swivel swivels both where shaft 175 connects to housing 112 and where shaft 175 connects to semi-hourglass 169. In other embodiments, freely rotatable swivel 118 swivels only where shaft 175 connects to semi-hourglass 169. This second embodiment is best illustrated by FIG. 4b.

In FIG. 4b, semi-hourglass 169 also comprises holes 177 and 179 in distal end 181. These holes allow a shaft 183 to be placed in distal end 181 such that a crane hook can be attached to freely rotatable swivel 118. In certain embodiments, shaft 183 is secured in holes 177 and 179 through pin 185.

As also demonstrated in FIG. 4b, shaft 175 may connect to housing 112 through connectors 187 and 189. Connectors 187 and 189 are permanently attached to housing 112, such as through welding, in most embodiments. Connectors 187 and 189 comprise holes which allow for shaft 190 to be placed through holes in connectors 187 and 189 as well as through a hole in shaft 175. In one embodiment, shaft 190 is secured in the holes in connectors 187 and 189 and the hole in shaft 175 through a pin 192.

Shaft 175 has a connected ring 193 in certain embodiments. Ring 193 helps to secure shaft 175 in semi-hourglass 169. Ring 193 is permanently attached with shaft 175, e.g. through welding in many circumstances. In some embodiments, shaft 175 is also permanently attached to housing 112. This permanent attachment may also be through welding.

The sizes of semi-hourglass 169, shafts 175, 183, and 190 as well as the size of connectors 187 and 189 are not meant to be limiting. The skilled artisan can easily determine the appropriate size for each of the elements of freely rotatable swivel 118. Nor are the sizes of the holes in freely rotatable swivel 118 limiting. In certain embodiments, hole 171 in semi-hourglass 169 is about 1.5 inches in diameter. In other embodiments, hole 171 is about 2 inches, about 2.5 inches, or about 3 inches in diameter.

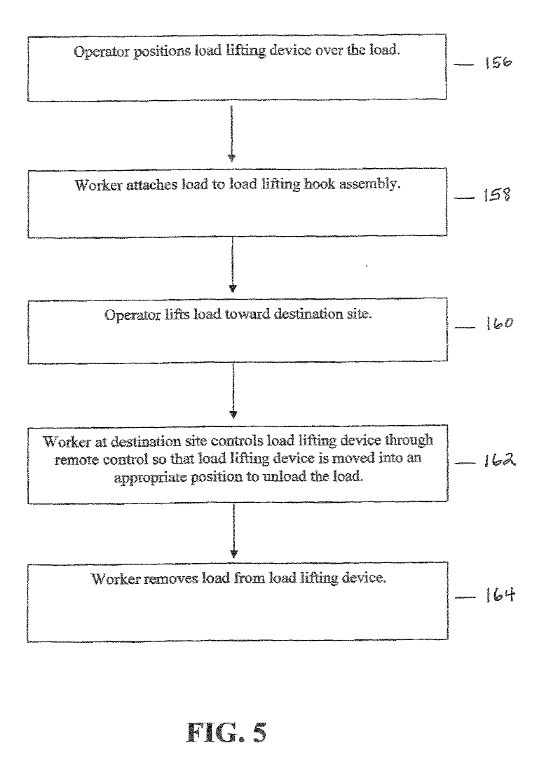

An embodiment demonstrating operation of the load lifting device 110 is shown in the flow diagram of FIG. 5. In this embodiment, load lifting device 110 has previously been attached with a crane or other applicable device. For example, a hoist line of a crane may be connected with freely rotatable swivel 118. In step 156, an operator positions load lifting device 110 over the load to be lifted into position by moving the crane or other applicable device to which load lifting device 110 is attached and using remote control 138 to control remote processing unit 134. In step 158, a rigger or other type of worker then attaches the load to load lifting hook assembly 114 of load lifting device 110. The operator then lifts the load toward its destination 160 by controlling both the crane or other applicable device upon which load lifting device 110 is connected and load lifting device 110. As shown in the flow chart of FIG. 5, 162, once the load is near its desired destination, a rigger or worker at the destination site controls load lifting device 110 through remote control 138 so that load lifting device 110 is moved into an appropriate position to unload the load. A rigger or other type of worker then removes the load from load lifting device 110, 164 and load lifting device 110 is used to lift another load.

Load lifting device 110 and methods of using load lifting device 110 are not limited to a specific application. However, load lifting device 110 has particular applicability in the movement of equipment and/or material in manufacturing plants, shipyards, or construction sites.

Any aspect or design described herein as “exemplary” is not necessarily to be construed as preferred or advantageous over other aspects or designs. Exemplary embodiments may be implemented as a method, apparatus, or article of manufacture. The word “exemplary” is used herein to mean serving as an example, instance, or illustration.

From the above discussion, one skilled in the art can ascertain the essential characteristics of the invention, and without departing from the spirit and scope thereof, can make various changes and modifications of the embodiments to adapt to various uses and conditions. Thus, various modifications of the embodiments, in addition to those shown and described herein, will be apparent to those skilled in the art from the foregoing description. Such modifications are also intended to fall within the scope of the appended claims.

What is claimed is:

1. A load lifting device comprising:
(a) a housing;
(b) a load lifting hook assembly mounted with the housing;
(c) a freely rotatable swivel mounted with the housing opposite the load lifting hook assembly, wherein the freely rotatable swivel can rotate around a vertical axis; and
(d) a rotational driving device located within the housing, wherein the rotational driving device interacts with the load lifting hook assembly and controls movement of the load lifting hook assembly along a vertical axis.

2. The load lifting device of claim 1 wherein the housing comprises a recess.

3. The load lifting device of claim 2 wherein there are at least two apertures and a platform in the recess.

4. The load lifting device of claim 3 wherein the platform supports the rotational driving device.

5. The load lifting device of claim 1 wherein the housing is spherical.

6. The load lifting device of claim 5 wherein the spherical housing has a 16 inch diameter.

7. The load lifting device of claim 1 wherein the housing is cylindrical.

8. The load lifting device of claim 1 wherein the load lifting hook assembly comprises a hook, a bearing assembly, and a shaft.

9. The load lifting device of claim 8 wherein the shaft extends into the housing.

10. The load lifting device of claim 9 further wherein the shaft comprises a collar located within the housing.

11. The load lifting device of claim 1 wherein the rotational driving device comprises a motor, a remote processing unit, a power source, and a remote control.

12. The load lifting device of claim 11 wherein the motor is a stepper motor.

13. The load lifting device of claim 11 wherein the power source is a rechargeable battery.

14. The load lifting device of claim 11 wherein the remote processing unit is controlled by the remote control, further wherein the remote control is a wireless remote transmitter.

15. The load lifting device of claim 1 wherein the load lifting hook assembly can be turned along a vertical axis 360 degrees in either direction.

16. The load lifting device of claim 1 wherein the freely rotatable swivel comprises a ring.

17. The load lifting device of claim 16 wherein the freely rotatable swivel further comprises a shaft.

18. The load lifting device of claim 1 further comprising a sensor.

19. A load lifting device comprising:
(a) a spherical housing comprising an interior, an exterior and a recess;
(b) a load lifting hook assembly comprising a hook and a shaft mounted with the housing;
(c) a freely rotatable swivel mounted with the spherical housing opposite the load lifting hook assembly, wherein the freely rotatable swivel can rotate around a vertical axis; and
(d) a rotational driving device comprising a geared motor, a remote processing unit, a power source, and a remote control located within the housing, wherein the gear of the motor of the rotational driving device interacts with the shaft of the load lifting hook assembly and controls movement of the load lifting hook assembly along a vertical axis.

20. A method of moving a load comprising:
(a) placing a load lifting device over a load to be moved, wherein the load lifting device comprises a housing; a load lifting hook assembly mounted with the housing; and a freely rotatable swivel mounted with the housing opposite the load lifting hook assembly;
(b) attaching the load to be moved to the load lifting hook assembly;
(c) lifting the load lifting device with the load toward a desired destination;
(d) moving the load lifting device with the load into position to unload the load at the desired destination; and
(e) removing the load from the load lifting device.
